(19) United States
(12) Patent Application Publication
(10) Pub. No.: US 2014/0077762 A1
(43) Pub. Date: Mar. 20, 2014

(54) SYSTEM AND METHOD FOR ELECTRIC VEHICLE (EV) CHARGING

(71) Applicant: Mike Spanos, Chandler, AZ (US)

(72) Inventor: Mike Spanos, Chandler, AZ (US)

(21) Appl. No.: 13/623,673

(22) Filed: Sep. 20, 2012

(51) Int. Cl. B60L 11/18

(52) U.S. Cl. CPC B60L 11/1824
USPC 320/109; 320/162

(57) ABSTRACT

A smart Electric Vehicle Supply Equipment (“EVSE”) that will accept input from different sources to determine the max rate of charge an Electric Vehicle (EV) can be safely charged at without overloading the electrical system of the residence. The system will also communication signals from the power company, fire department and police to reduce or eliminate the charging of the battery in the EV if the situation requires. The smart EVSE further comprises a non-invasive current and/or load sensing unit coupled to the power source for recharging the battery or batteries in the EV, cables to connect the load sensing unit to the EVSE, and optional wireless communication transmitter (sensor to EVSE), EVSE unit with compensating ability.

### CROSS REFERENCE TO RELATED APPLICATIONS

This application claims the benefit of U.S. Provisional Patent Application No. 61/537,395, filed on Sep. 20, 2011, the contents of which are incorporated herein by reference, as if fully set forth herein.

### BACKGROUND OF THE INVENTION

1. Field of the Invention

The present invention relates generally to the field of electric cars and more specifically relates to charging systems for electric cars.

2. Related Art

Electric cars or electric vehicles (“EVs”) are becoming increasingly prevalent throughout the world, and especially so in the United States of America. The growth of electric cars is tied to many factors, including a growing awareness of environmental issues, reductions in the price of the technology, and a desire to decrease the dependence on fossil fuels for the overall economy. Taken together, these factors, as well as many others, has driven automobile manufacturers to rapidly adopt and deploy electric vehicles in the marketplace and consumer adoption rates are rapidly rising to take advantage of the many options now available.

When purchasing an EV, one of the practical challenges that meets the new owner is the seemingly obvious requirement that they will need ready access to a reliable source of electricity at their home in order to keep the battery for their EV charged and ready to go. While the concept of plugging the EV into an electrical outlet is, on its face, a straightforward proposition, the practical realities are somewhat more challenging.

For example, a typical Electric Vehicle Supply Equipment (“EVSE”) unit is a “dumb” unit (e.g. a unit without any control logic circuitry) that is connected to the residence power system via a wall outlet. In this scenario, the system is considered to be just another home appliance by the power company and, therefore, must fall into overall load balancing calculations for the maximum electrical load or the residence. This is the same calculation done for adding an electric dryer or AC unit to a residence. Being the units is charging at a fixed or constant rate, the maximum current load (in amperes) the unit is allowed to “pull” or “draw” from the electrical system is relatively low and, as a result, it may require more than 14 hours to complete a full charge of the EV battery in a standard configuration.

Additionally, the typical EVSE unit with a fixed current load may become a more problematic issue with older residences that have lower rated service panels (e.g., rated at or below 100 amperes). In these situations, charging even a single EV can be impossible due to the load restrictions for the residence and may require the costly installation of a second meter or require an upgrade to the main power supply panel of the residence.

Given the significant electrical demands for charging the batteries in electric vehicles, and the inadequate infrastructure found in many homes today, it is possible a significant number of homes will be unable to support the load associated with charging the EV battery. Accordingly, without additional improvements in the equipment and methods used to charge batteries for electric vehicles, the adoption of electric vehicles, and the ability to reap the benefits from the use of the electric vehicle, will continue to be sub-optimal.

### BRIEF SUMMARY OF THE INVENTION

The preferred embodiments of the present invention provide for the monitoring of the current drawn from a current source by a plurality of devices, including at least one charging unit for charging the battery of an EV. The current flow to the charging unit for the EV battery is adjusted from a maximum value to a minimum value, based on the total current available from the current source and the demands of the other devices that are simultaneously drawing current from the current source. The total amount of current drawn from the current source for charging the EV battery will be “throttled” as necessary to reduce or eliminate the possibility of overloading the current source with excessive demand, possibly tripping the current source circuit. This methods disclosed herein provide protection against accidental triggering of the charging unit, real time system calibration, high strength materials for the enclose to prevent damage during use, sealed system for fluid resistance, redundant communication to insure proper data feed to the system.

The most preferred embodiments of the EVSE of the present invention comprise an electrical outlet connector for use in standard 220 V appliance outlets, a cord connecting the outlet to the EVSE main system box, a main system box housing the electronics for communication to a remote sensor via a hard wired communication link or a wireless communication link, an input panel for programming the EVSE system, a digital screen for monitoring the parameters and operation of the EVSE system, a wireless communication link for enabling communications with a utility company (e.g., power company), the police department or fire department or other emergency response organizations and vehicles, an electrical connection from the EVSE main system box to the automotive connector, and an industry standard EV automotive connector.

### BRIEF DESCRIPTION OF THE SEVERAL VIEWS OF THE DRAWINGS

The preferred embodiments of the present invention will hereinafter be described in conjunction with the appended drawings, wherein like designations denote like elements, and:

FIG. 1 is a schematic diagram of a typical EVSE system;

FIG. 2 is a schematic diagram of a smart EVSE system with hard wired connection in accordance with a preferred exemplary embodiment of the present invention;

FIG. 3 is a schematic diagram of a smart EVSE system with a wireless connection in accordance with a preferred exemplary embodiment of the present invention;

FIG. 4 is a schematic diagram of a smart EVSE system with communication capabilities for communicating with a utility company in accordance with a preferred exemplary embodiment of the present invention;

FIG. 5 is a schematic diagram of a smart EVSE system with communication capabilities for communicating with police and fire departments, as well as various emergency response vehicles in accordance with a preferred exemplary embodiment of the present invention; and

FIG. 6 is a schematic diagram of a smart EVSE system with smart phone communication capabilities for charging two or more vehicles at the same time in accordance with a preferred exemplary embodiment of the present invention.

### DETAILED DESCRIPTION OF THE INVENTION

In contrast to the presently known EVSE charging systems, the various preferred embodiments of the EVSE of the present invention are connected to the residence power system via a wall outlet and is still considered an appliance by the power company and it is determined with the max load is for the system based on load calculations of the residence other appliances and max power at the box and this max draw is input into the EVSE computer system as the FAIL safe max load. Then the EVSE sensor is connected to the main power line servicing the electrical panel for the residence and it determines the load the residence in real time. For example if you have a 200 amp panel and you have an AC unit drawing 25 amps, a refrigerator drawing 15 amps, a TV drawing 5 amps and lights drawing 5 amps your system is drawing 50 amps the Calculation for the safe load for a dumb unit will only allow the unit to Draw 20 amps period so you are using 70 amps but you have 200 amps available. The smart systems sees you are using 50 amps and then will draw a safe percent of the available amps left in the system for charging in this case we will use a safe draw load of 85% so the system will pull 85% of the 150 amps available or 127.5 amps NOT the 20 amps the dumb units draws. The smart system will also reduce the charging rate in real time to accommodate additional loads in the system. To continue this example you are drawing 50 amps for the systems with the AC, TV, refrigerator and lights now the pool pump kicks on and adds and extra 15 amps to the system. The load sensor instantly detects the load and reduces it EVSE to the safe load of 20 amps then the computer does a new calculation of the load in the system 50 amps+15 amps=65 amps remaining available 135 amps and a safety margin of 15% the EVSE now is reset to charge at 114.75 amps all this is done in less then 3 seconds. The smart EVSE of the present invention acts as a real time load balancing system, taking the additional load of the EVSE charging system into account as a variable load.

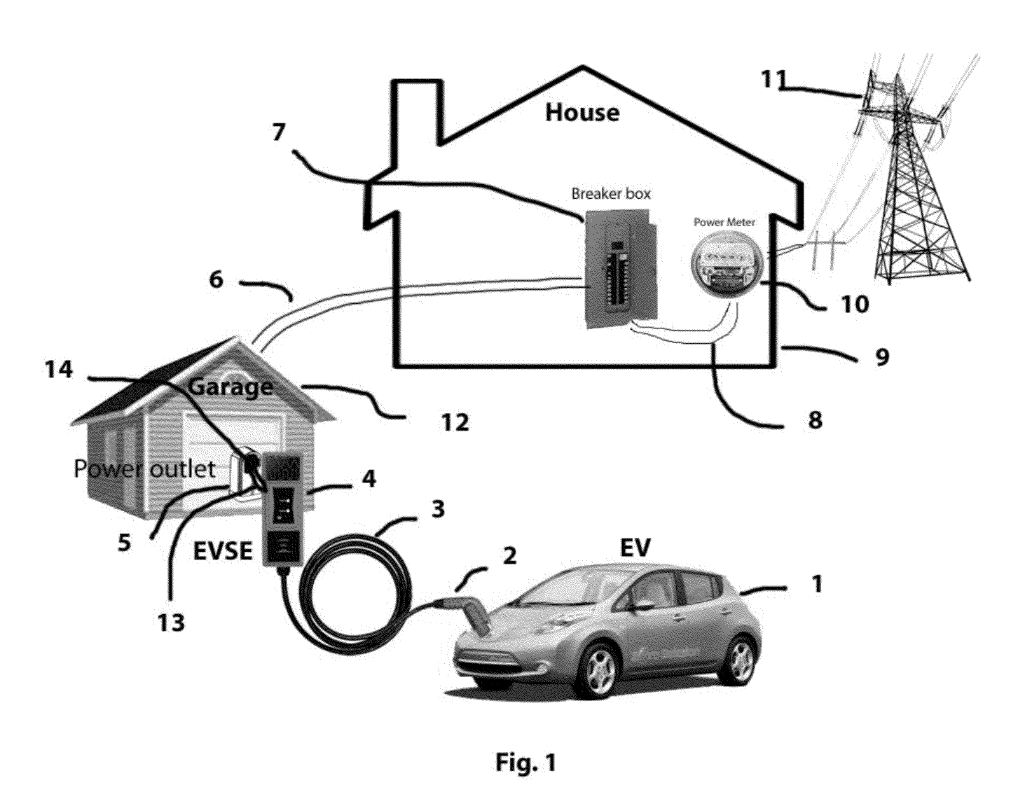

Referring now to FIG. 1, a typical EVSE 4 unit, with cables 3, connected to automotive standard connector 2, connected to EV 1. The power for the EVSE is delivered through cables 13 thru the standard 220 plug 14 connected to the outlet 5, which is mounted to the wall of the garage 12 and fed power via lines 6 to breaker box 7 that is mounted to the house 9 and connected to the meter 10 via lines 8. The meter is connected to the power company main lines 11. This is a standard arrangement for charging the batter of an EV and suffers from the problems described above, including the potential to trip the supply circuit for the residence, thereby requiring service to the main electrical service panel.

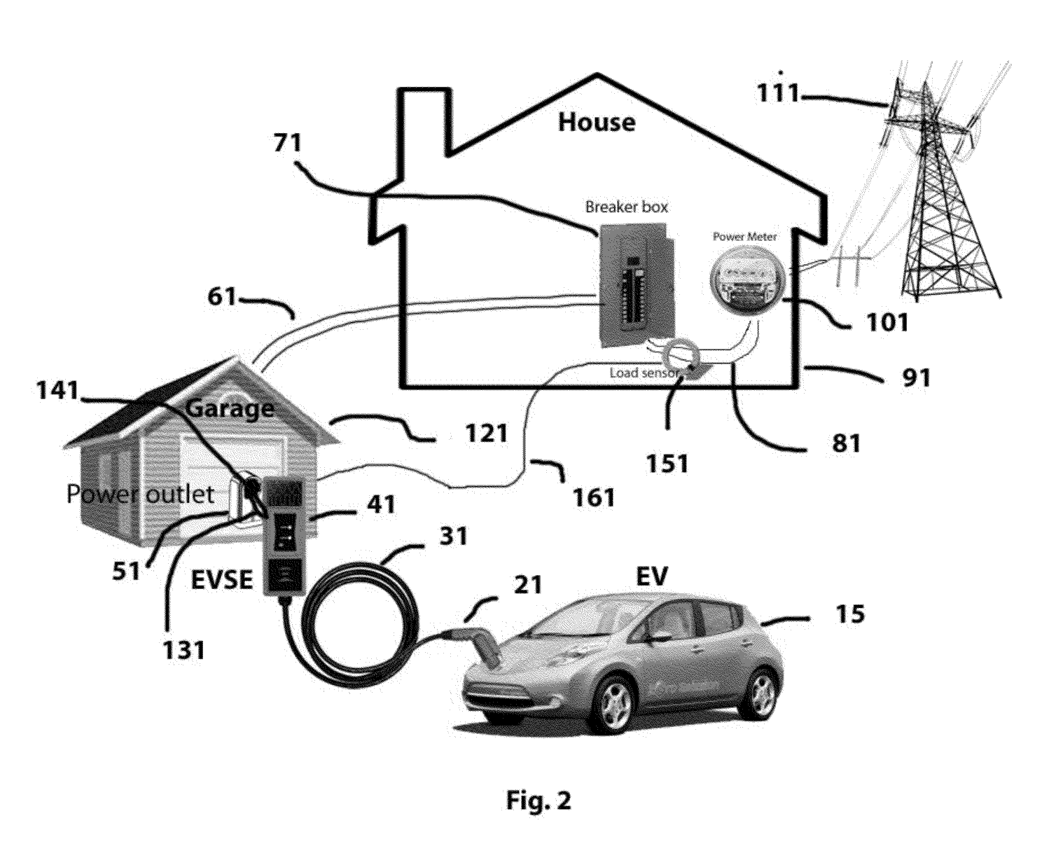

Referring now to FIG. 2, Smart EVSE 41 unit, with cables 31, connected to automotive standard connector 21, connected to EV 15. The power for the EVSE 41 is delivered thru cables 131 thru the standard 220 plug 141 connected to the outlet 51. Which is mounted to the wall of the garage 121 and fed power via lines 61 to breaker box 71 that is mounted to the house 91 and connected to the meter 101 via lines 81. The meter is connected to the power company main lines 111. The smart EVSE 41 is also connected via hard line 161 to the load sensor 151 to measure the real time load of the residence 91.

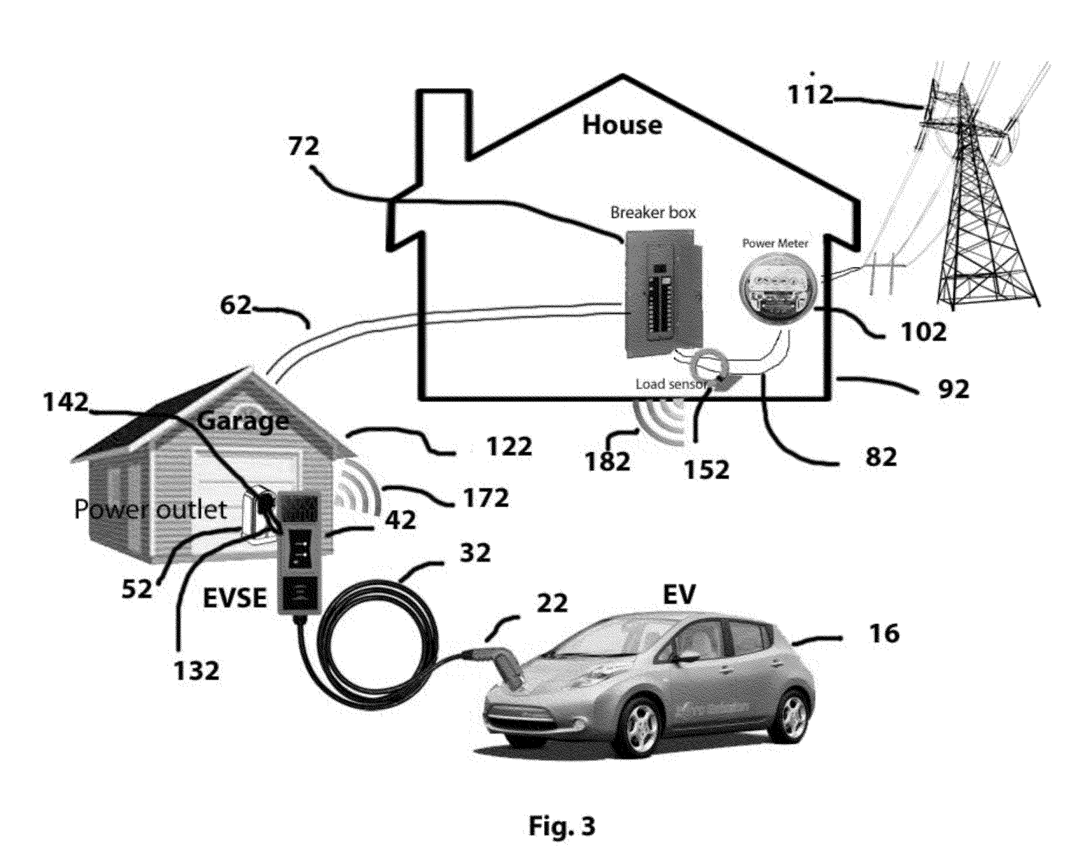

Referring now to FIG. 3, Smart EVSE 42 unit, with cables 32, connected to automotive standard connector 22, connected to EV 16. The power for the EVSE 42 is delivered thru cables 132 thru the standard 220 plug 142 connected to the outlet 52. Which is mounted to the wall of the garage 122 and fed power via lines 62 to the breaker box 72, which is mounted to the house 92 and connected, to the meter 102 via lines 82. The meter is connected to the power company main lines 112. The smart EVSE 42 is also connected via Wireless transmitter 172 to the load sensor 152 via wireless receiver 182 to measure the real time load of the residence 92.

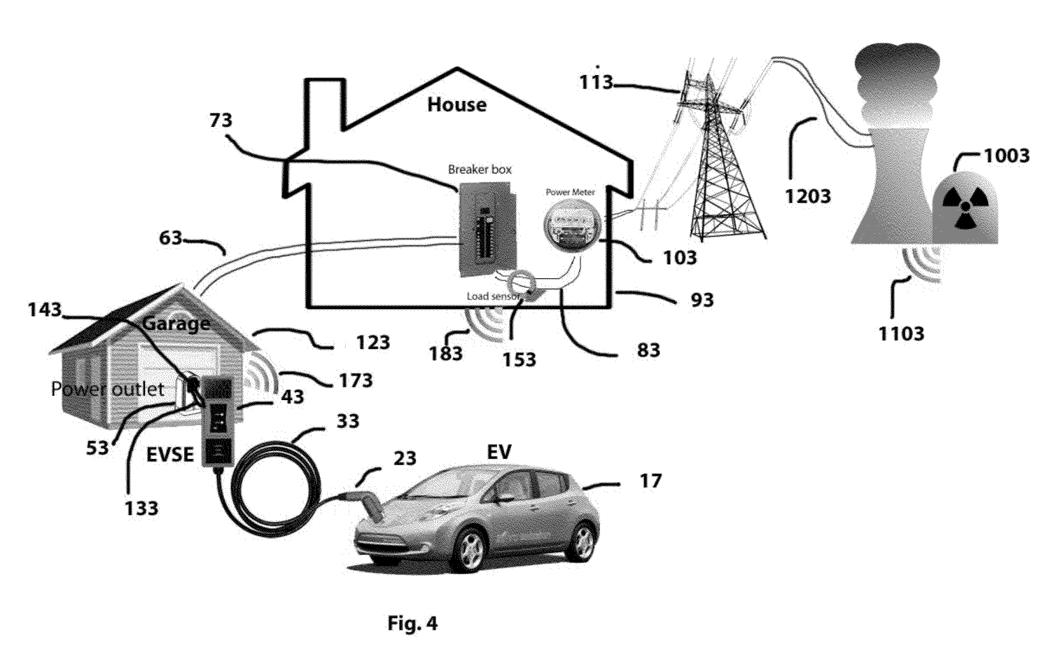

Referring to FIG. 4, Smart EVSE 43 unit, with cables 33, connected to automotive standard connector 23, connected to EV 17. The power for the EVSE 43 is delivered thru cables 133 thru the standard 220 plug 143 connected to the outlet 53. Which is mounted to the wall of the garage 123 and fed power via lines 63 to the breaker box 73, which is mounted to the house 93 and connected, to the meter 103 via lines 83. The meter is connected to the power company main lines 113. The smart EVSE 43 is also connected via Wireless transmitter 173 to the load sensor 153 via wireless receiver 183 to measure the real time load of the residence 93. A second source of data for the smart EVSE 43 can be received from the local power company 1003 that is supplying power to the residence 93 via cables 1203 and towers 113 and can directly communicate via wireless connection 1103. This additional data provided to the EVSE 43 will be evaluated and the LOWER of the 2 proposed settings would be selected as the charging rate.

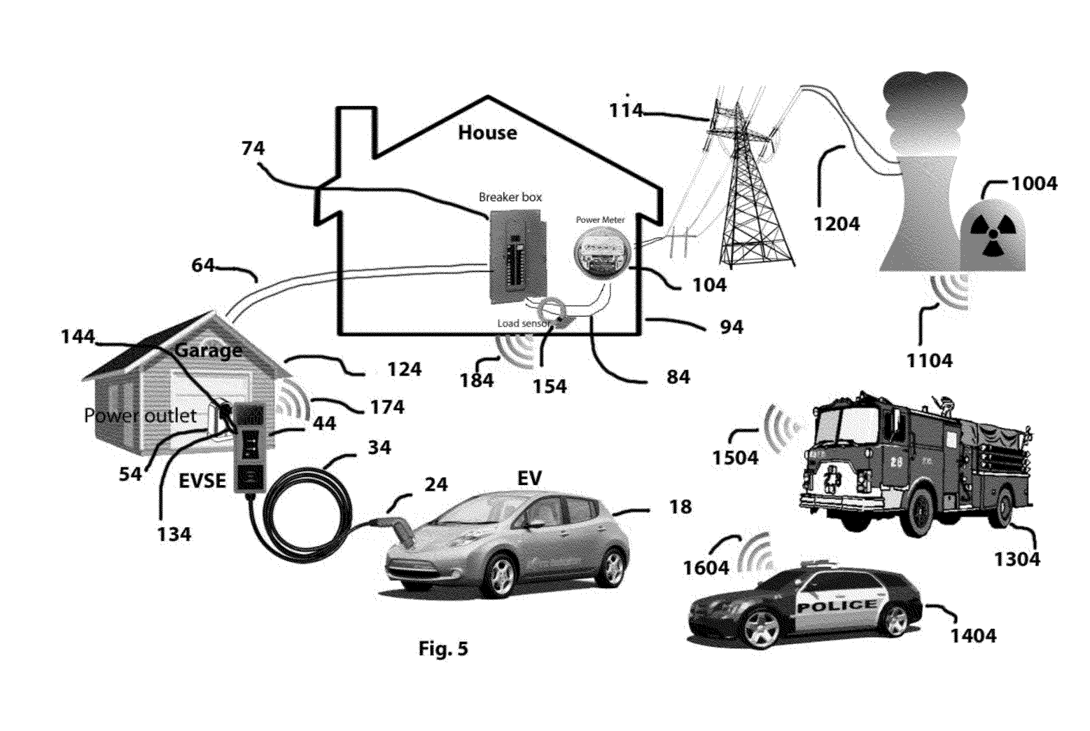

Referring now to FIG. 5, Smart EVSE 44 unit, with cables 34, connected to automotive standard connector 24, connected to EV 18. The power for the EVSE 44 is delivered thru cables 134 thru the standard 220 plug 144 connected to the outlet 54. Which is mounted to the wall of the garage 124 and fed power via lines 64 to the breaker box 74, which is mounted to the house 94, and connected, to the meter 104 via lines 84. The meter is connected to the power company main lines 114. The smart EVSE 44 is also connected via Wireless transmitter 174 to the load sensor 154 via wireless receiver 184 to measure the real time load of the residence 94. A second source of data for the smart EVSE 44 can be received from the local power company 1004 that is supplying power to the residence 94 via cables 1204 and towers 114 and can directly communicate via wireless connection 1104. In addition, Police vehicles 1404 and Fire department vehicles 1304 can over ride both load sensor data 184 and the power company data 1104 and command the EVSE 44 to completely discontinue charging if required.

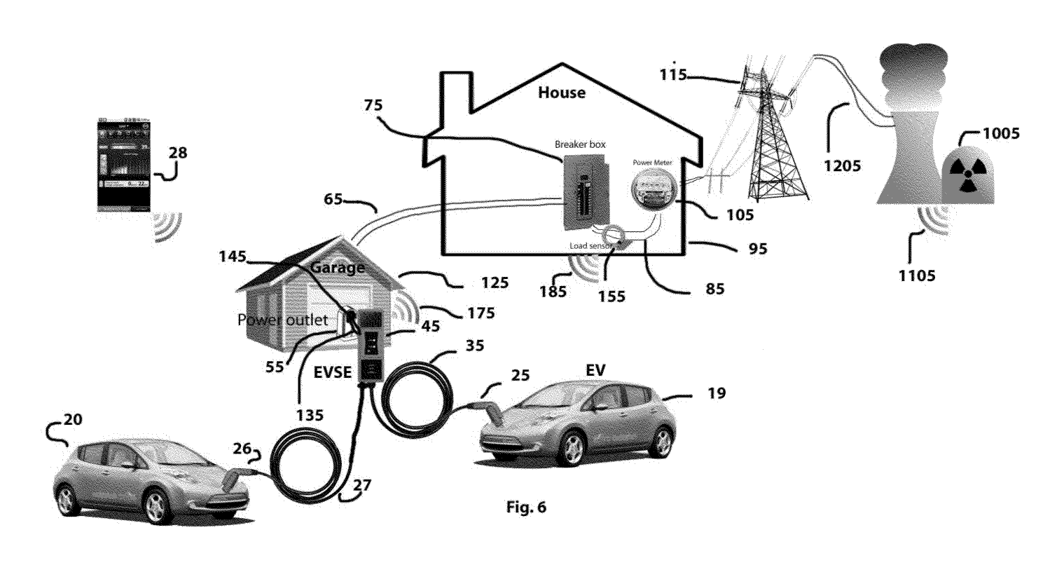

Referring now to FIG. 6, Smart EVSE 45 unit, with dual cables 35 and 27, connected to automotive standard connector 25 and 26 respectively, connected to EV 19 and 20 respectively. The power for the EVSE 45 is delivered thru cables 135 thru the standard 220 plug 145 connected to the outlet 55. Which is mounted to the wall of the garage 125 and fed power via lines 66 to the breaker box 75, which is mounted to the house 95, and connected, to the meter 105 via lines 85. The meter is connected to the power company main lines 115. The smart EVSE 45 is also connected via Wireless transmitter 175 to the load sensor 155 via wireless receiver 185 to measure the real time load of the residence 95. A additional source of data for the smart EVSE 44 can be received from smart phone 28 that can directly communicate via wireless The smart Phone 28 can be used to apportion the amount of available power via a percentage to each of the EV's 19 and 20 depending on the user's specific needs.

The method of the present invention includes the steps of connecting the EV battery charging system to the electrical circuit for a residence or other building, setting the total available current settings (maximum current draw for all loads), monitoring the current drawn by all devices (other than the EV battery charging unit) that are connected to the electrical system for the residence of other building, and adjusting the current supplied to the EV battery charging system, based on the amount of available current that is not being used by the other devices that are connected to the residence or other building. In the most preferred embodiments of the present invention, the amount of current supplied to the EV battery charging system may further reduced by some safety factor (e.g., only 85% of the available current is supplied for charging the EV battery), thereby providing a safety cushion for sudden changes in the current requirements of the main electrical supply circuit.

The current being drawn by all of the devices connected to the main electrical supply panel or circuit for the residence or other building can be detected and measured by any means known to those skilled in the art (e.g., current transformer, in-line monitoring system, etc.). The output of any such device is a reading of the amperes being drawn by each device connected to the electrical circuit. The total of all devices, plus the amount being drawn by the EV battery charging system is constantly adjusted as the loads change to ensure that the total load is always kept within the safety parameters of the electrical circuit. The amount of current supplied to the EV battery charging system fluctuates, based on the amount of current being drawn by the other devices and will be some fraction of the remaining current available from the electrical supply system.

The following are all representative preferred exemplary embodiments of the present invention.

A Smart EVSE unit comprising: EVSE control box for charging one car; Cable connecting box to standard Automotive connector; Standard automotive connector; Supply cable connected to EVSE box and connected to 220 Plug; Data cable connecting EVSE box to Load sensor; and Software in the EVSE box to use the data from the sensor and residence max load to calculate max charge parameters.

A Smart EVSE unit in claim one but with multiple cables and connectors for charging 2 or more cars.

A Smart EVSE unit in claim one but with software and to communicate with the local power company and enable them to send additional data to the EVSE during high-energy usage to reduce the charge rate if required.

A Smart EVSE unit in claim one but with software and to communicate with the Police and fire department vehicles and enable them to override the charging schedule and shut the system down from charging in case of an emergency.

A Smart EVSE unit in claim two but with the software to communicate with smart phone and allow user to apportion the charge via percentage to each EV charging.

A Smart EVSE unit in claim one but with multiple load sensors for redundant back up of data and software to verify both sensors are sending the same data.

A Smart EVSE unit in claim two but with multiple load sensors for redundant back up of data and software to verify both sensors are sending the same data.

A Smart EVSE unit in claim two but with software and to communicate with the local power company and enable them to send additional data to the EVSE during high-energy usage to reduce the charge rate if required.

A Smart EVSE unit in claim two but with software and to communicate with the Police and fire dept. vehicles and enable them to override the charging schedule and shut the system down from charging in case of an emergency.

A Smart EVSE unit comprising: EVSE control box for charging one car; Cable connecting box to standard Automotive connector; Standard automotive connector; Supply cable connected to EVSE box and hard wired to the main house power panel; Data cable connecting EVSE box to Load sensor; and Software in the EVSE box to use the data from the sensor and residence max load to calculate max charge parameters.

A Smart EVSE unit in claim ten but with multiple cables and connectors for charging 2 or more cars.

A Smart EVSE unit in claim ten but with software and to communicate with the local power company and enable them to send additional data to the EVSE during high-energy usage to reduce the charge rate if required.

A Smart EVSE unit in claim ten but with software and to communicate with the Police and fire department vehicles and enable them to override the charging schedule and shut the system down from charging in case of an emergency.

A Smart EVSE unit in claim eleven but with the software to communicate with smart phone and allow user to apportion the charge via percentage to each EV charging.

A Smart EVSE unit in claim ten but with multiple load sensors for redundant back up of data and software to verify both sensors are sending the same data.

A Smart EVSE unit in claim eleven but with multiple load sensors for redundant back up of data and software to verify both sensors are sending the same data.

A Smart EVSE unit in claim eleven but with software and to communicate with the local power company and enable them to send additional data to the EVSE during high energy usage to reduce the charge rate if required.

A Smart EVSE unit in claim eleven but with software and to communicate with the Police and fire dept. vehicles and enable them to override the charging schedule and shut the system down from charging in case of an emergency.

In summary, the present invention teaches a EVSE battery charging system and method that provides for an optimized charging environment for the charging of the battery system for one or more electric vehicles. The battery charging system and method of the present invention allows the EV to be connected to the residential power source without any upgrade or additional expense. By controlling the amount of current and, by extension, the rate of charge for the EV battery, the system can minimize or prevent any undesired short circuit of the system due to overload conditions associated with the charging of the EV battery.

From the foregoing description, it should be appreciated that the EVSE battery charging system and methods disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. An electrical vehicle charging system comprising:
an electric vehicle, the electric vehicle comprising at least one rechargeable battery;
a power source;
at least one cable coupling the at least one rechargeable battery to the power source;
a load sensor coupled to the power source, the load sensor sensing an electrical load on the power source; and
a charging control unit coupled to the load sensor and the power source, the charging control box monitoring the electrical load on the power source via the load sensor, the charging control unit regulating a recharge rate of the at least one rechargeable battery based on at least one charging parameter.

2. The electrical vehicle charging system of claim 1 wherein the at least one charging parameter comprises the electrical load on the power source.

3. The electrical vehicle recharging system of claim further comprising a communication module, the communication module providing at least one communication signal received from at least one of a utility company, a government agency, and an emergency response organization to the charging control unit wherein the at least one communication signal comprises a charging control parameter for regulating the recharge rate of the at least one rechargeable battery.

4. A method of charging at least one rechargeable battery in an electric vehicle, the method providing the steps of:
connecting the least one rechargeable battery to a power source;
monitoring an electrical load on the power source; and
regulating a recharge rate for the at least one rechargeable battery based on the electrical load on the power source.
